(19) United States
(12) Patent Application Publication
(10) Pub. No.: US 2024/0199114 A1
(43) Pub. Date: Jun. 20, 2024

(54) VEHICLE CONTROL DEVICE, VEHICLE CONTROL METHOD, AND STORAGE MEDIUM

(71) Applicant: TOYOTA JIDOSHA KABUSHIKI KAISHA, Toyota-shi (JP)

(72) Inventor: Hiroaki KATAOKA, Toyota-shi (JP)

(73) Assignee: TOYOTA JIDOSHA KABUSHIKI KAISHA, Toyota-shi (JP)

(21) Appl. No.: 18/452,930

(22) Filed: Aug. 21, 2023

(30) Foreign Application Priority Data
Dec. 15, 2022 (JP) 2022-200484

(51) Int. Cl. B62D 6/00

(52) U.S. Cl. CPC B62D 6/001

(57) ABSTRACT

The vehicle control device executes steering control for matching a lateral control amount of the vehicle with a target control amount acquired based on a surrounding environment of the vehicle. When the steering control is being executed, the vehicle control device sets an upper limit value of the target control amount to a larger value as a stopping collision risk at which the vehicle collides with an object is lower when it is assumed that the steering control is stopped, and executes the steering control so that the control amount does not become larger than the upper limit value.

### CROSS-REFERENCE TO RELATED APPLICATION

This application claims priority to Japanese Patent Application No. 2022-200484 filed on Dec. 15, 2022, incorporated herein by reference in its entirety.

### BACKGROUND

### 1. Technical Field

The present disclosure relates to a vehicle control device that executes steering control for causing a control amount for a vehicle in a lateral direction to coincide with a target control amount acquired based on a surrounding environment of the vehicle, a vehicle control method for a computer mounted on a vehicle to execute steering control, and a storage medium storing a program that causes a computer mounted on a vehicle to execute steering control.

### 2. Description of Related Art

Conventionally, there has been known a vehicle control device that executes steering control such as Lane Tracing Assist (LTA), Advanced Drive Traffic Jam Assist (ADTJA), and Lane Change Assist (LCA).

When a specific recognition situation is not caused during the execution of LTA, the vehicle control device (hereinafter, referred to as a “conventional device”) described in Japanese Unexamined Patent Application Publication No. 2019-14369 (JP 2019-14369 A), for example, controls the steering angle such that the magnitude of the steering angle does not exceed a first steering angle guard value and the magnitude of the steering angular velocity does not exceed a first steering angular velocity guard value. The specific recognition situation is a situation in which only one of the right division line and the left division line of the traveling lane is recognized and the one recognized division line changes between the right division line and the left division line. When a specific recognition situation is caused, the position of the target travel line greatly changes. Therefore, there is a possibility that the behavior of the vehicle becomes unstable. Therefore, when a specific recognition situation is caused, the conventional device controls the steering angle such that the magnitude of the steering angle does not exceed a “second steering angle guard value smaller than the first steering angle guard value” and the magnitude of the steering angular velocity does not exceed a “second steering angular velocity guard value smaller than the first steering angular velocity guard value”. Accordingly, it is possible to reduce the possibility that the behavior of the vehicle becomes unstable due to a large change in the position of the target travel line.

### SUMMARY

When the steering control is stopped for some reason, the risk of a collision of the vehicle with an object increases as compared with when the steering control is not stopped. The risk of a collision due to the stop of the steering control is referred to as a “stopping collision risk”. Such a stopping collision risk is not constant, and changes depending on the external environment of the vehicle, the travel state of the vehicle, the state of the driver, and the like.

The conventional device does not set an upper limit value (a steering angle guard value and a steering angular velocity guard value) of a control amount (a steering angle) for the steering control in consideration of the stopping collision risk. It is assumed that the upper limit value is set to a constant value on the assumption that the stopping collision risk is constant. When the upper limit value is set to a low value, it takes a long time for the control amount to coincide with the target control amount. Due to this, the steering control may give the driver an uncomfortable feeling. When the upper limit value is set to a high value, on the other hand, the possibility that the vehicle collides with another object when the steering control is stopped is increased.

The present disclosure has been made to address the above-mentioned issue. That is, an object of the present disclosure is to provide a vehicle control device capable of reducing the possibility of causing a driver to feel uncomfortable due to a long time required for a control amount to coincide with a target control amount, and reducing the possibility of a vehicle colliding with another object when steering control is stopped.

The drive assist device according to the present disclosure (hereinafter referred to as a “present disclosure device”) is a vehicle control device that executes steering control for causing a control amount for a vehicle in a lateral direction to coincide with a target control amount acquired based on a surrounding environment of the vehicle, in which the vehicle control device is configured to: set an upper limit value of the target control amount, when the steering control is executed, to a larger value as a stopping collision risk that the vehicle collides against an object when it is assumed that the steering control is stopped is lower; and execute the steering control such that the control amount does not become larger than the upper limit value.

According to the present disclosure device, the upper limit value is set to a larger value as the stopping collision risk is lower, and the steering control is executed such that the control amount does not become larger than the upper limit value. Consequently, it is possible to reduce the possibility that the time required for the control amount to coincide with the target control amount becomes longer, and to reduce the possibility that the vehicle collides with another object even if the steering control is stopped.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a driving support apparatus according to an embodiment of the present disclosure;

FIG. 2 is a flow chart for explaining the operation of the driving support device according to the embodiment of the present disclosure; and

FIG. 3 is an explanatory diagram of a time-series change in the steering torque when LTA is stopped and a predicted route when LTA is stopped.

### DETAILED DESCRIPTION OF EMBODIMENTS

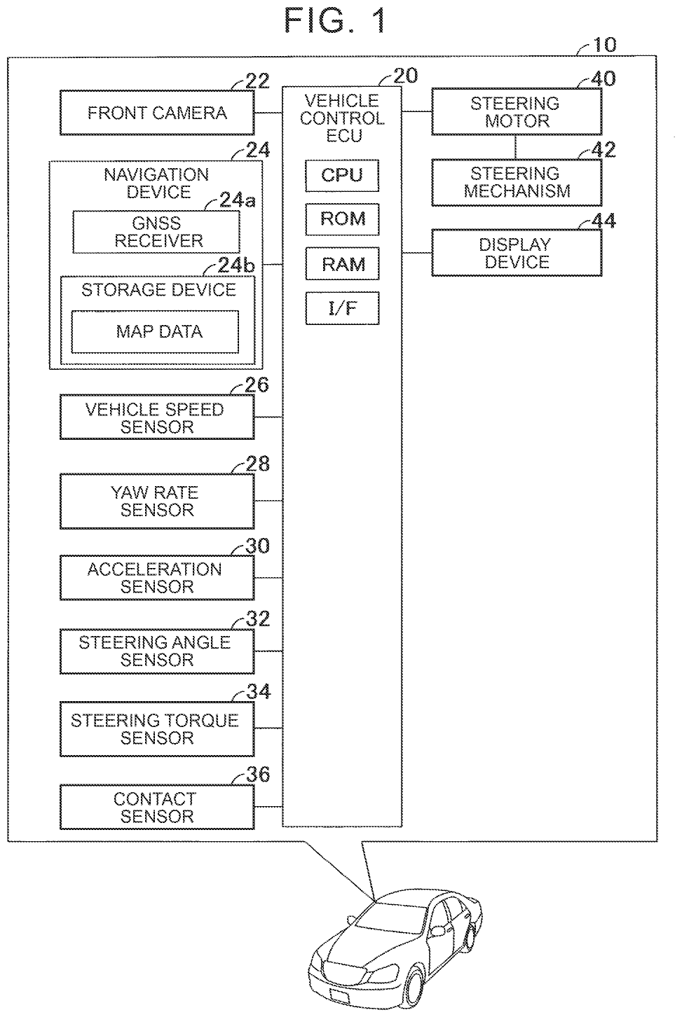

As illustrated in FIG. 1, the vehicle control device (hereinafter, referred to as “the device 10”) according to the present embodiment is applied to a vehicle VA. The device 10 comprises the components shown in FIG. 1.

The vehicle control ECU 20 executes steering control for controlling the steering motor 40 to be described later so as to make the control amount C in the lateral direction (vehicle width direction) of the vehicle VA coincide with the “target control amount Ctgt acquired based on the surrounding environment of the vehicle VA”. Hereinafter, the vehicle control ECU 20 will be referred to as “ECU 20”.

In the present specification, “ECU” is an electronic control device including a microcomputer as a main part. ECU is also referred to as a control unit, a controller, or a computer. The microcomputer includes a CPU (processor), a ROM, RAM, and interfaces (I/F). At least one function of ECU 20 may be implemented by a plurality of ECU.

The front camera 22 captures an image of a scene in front of the vehicle VA. The front camera 22 acquires boundary information and object information based on the image data. The boundary information is information about the position of the “boundary partitioning the self-traveling region in which the vehicle VA is currently traveling and the adjacent-traveling region adjacent to the self-traveling region” with respect to the vehicle VA. The object information is information regarding a position of an object existing in front of the vehicle VA with respect to the vehicle VA. The front camera 22 transmits the border information and the object information to ECU 20.

The navigation device 24 comprises a Global Navigation Satellite System (GNSS) receiver 24a and a storage device 24b. GNSS receiver 24a receives GNSS from a plurality of satellites. GNSS signal is a signal for specifying “latitude and longitude” representing the present position of the vehicle VA. The map information includes information on a road type. The road type is a type of an expressway, a national road of a general road, a prefectural road of a general road, or the like.

The navigation device 24 identifies the current position of the vehicle VA based on GNSS signal, and identifies the type of the road corresponding to the current position of the vehicle VA based on the map information. The navigation device 24 transmits, to ECU 20, the road type information regarding the identified road type.

The vehicle speed sensor 26 detects a vehicle speed Vs representing the speed of the vehicle VA. The yaw rate sensor 28 detects a yaw rate Yr of the vehicle VA. The acceleration sensor 30 detects an acceleration Gx of the vehicle VA in the front-rear direction and an acceleration Gy of the vehicle VA in the lateral direction (vehicle-width direction). The acceleration Gy is also referred to as a lateral acceleration Gy. The steering angle sensor 32 detects the steering angle θ of the steered wheels of the vehicle VA. The steering torque sensor 34 detects a steering torque Tr representing a torque acting on a steering shaft (not shown). The steering shaft is coupled to a steering wheel (not shown) of the vehicle VA. The steering torque sensor 34 detects a steering torque Tr for turning the vehicle VA clockwise as a positive value. The steering torque sensor 34 detects a steering torque Tr for turning the vehicle VA to the left as a negative value. The contact sensor 36 detects the driver's contact with the steering wheel.

The steering motor 40 is incorporated in the steering mechanism 42. The steering mechanism 42 is a mechanism for turning the steered wheels in accordance with an operation of the steering wheel. In response to an instruction from ECU 20, the steering motor 40 causes the steering mechanism 42 to generate an assist torque for assisting the steering wheel. Further, the steering motor 40 causes the steering mechanism 42 to generate an automatic steering torque for changing the steering angle of the steered wheels.

The display device 44 displays a presentation window for presenting the height of the upper limit control amount (upper limit value) Clmt of the control amount C to the driver.

### Operation

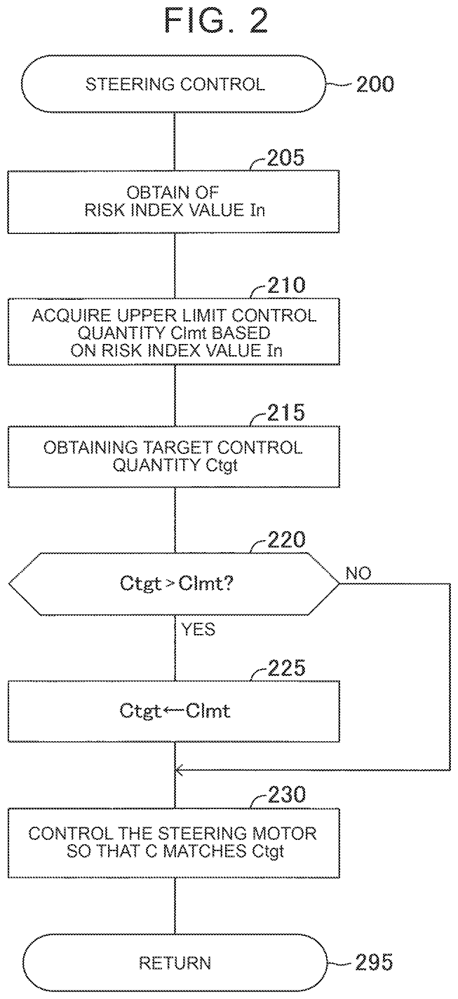

Referring to the flow chart shown in FIG. 2, the operation of ECU 20 of the device 10 will be described.

When the steering control is executed, CPU of ECU 20 (“CPU” refers to CPU of ECU 20 unless otherwise specified) is executed every time a predetermined period elapses in CPU shown in FIG. 2. When the appropriate time point has arrived, CPU starts the process from step 200 of FIG. 2 and executes step 205 to step 220 in sequence.

The step 205: CPU acquires a risk index value In representing a risk that the vehicle VA collides with another object (hereinafter, referred to as “collision risk upon stopping”) when it is assumed that the steering control is stopped for some reason. The higher the stopping collision risk, the greater the risk index value In. A specific example of acquiring the risk index value In will be described later.

The step 210: CPU acquires the upper limit control quantity Clmt based on the risk index value In. Specifically, CPU sets the upper limit control quantity Clmt to a larger value as the risk index value In is smaller (that is, as the stopping-time collision risk is lower).

The step 215: CPU acquires the target control quantity Ctgt based on the information representing the surrounding environment of the vehicle VA. The information representing the surrounding environment includes at least white line information.

The step 220: CPU determines whether or not the target control amount Ctgt is larger than the upper limit control amount Clmt.

If the target control amount Ctgt is greater than the upper limit control amount Clmt, CPU determines “Yes” in step 220. CPU then performs steps 225 and 230. The step 225: CPU sets the target control amount Ctgt to a value corresponding to the upper limit control amount Clmt.

The stepping 230: CPU controls the steering motor 40 so that the control amount C coincides with the target control amount Ctgt.

After that, CPU proceeds to step 295 and ends the routine.

On the other hand, when the target control amount Ctgt is equal to or less than the upper limit control amount Clmt, CPU determines “No” in step 220 and proceeds to step 230. After that, CPU proceeds to step 295 and ends the routine.

As described above, according to the present device 10, the upper limit control quantity Clmt is set to be larger as the stopping-time collision-risk is lower. Therefore, when the collision risk at the time of stopping is low, it is possible to reduce the possibility that the time until the control amount matches the target control amount becomes long. Further, when the collision risk at the time of stopping is high, the possibility that the vehicle collides with another object can be reduced even if the steering control is stopped.

### Steering Control

Examples of the steering control to which the present embodiment is applicable include lane keeping control and lane change support control.

### Lane Keeping Control

The lane keeping control is a control for changing the lateral position of the vehicle VA so that the lateral position of the vehicle VA maintains the vicinity of the center (predetermined position) of the self-traveling area (self-lane) in which the vehicle VA is traveling. The lane keeping control includes a first lane keeping control and a second lane keeping control.

The first lane keeping control is a control in which the driver needs to grip the steering wheel. An exemplary first lane keeping control is LTA. Details of the first lane keeping control are described in Japanese Unexamined Patent Application Publication No. 2019-14369 (JP 2019-14369 A).

The second lane keeping control is a control in which the driver does not need to grip the steering wheel when the vehicle speed Vs is equal to or lower than the upper limit vehicle speed Vlmt. An exemplary second lane keeping control is ADTJA. However, in the second lane keeping control, when the vehicle speed Vs becomes larger than the upper limit vehicle speed Vlmt, the driver needs to grip the steering wheel.

### Lane Change Support Control

The lane change support control is a control for supporting at least a part of a steering operation of a driver for changing a lane from a self-traveling area (self-lane) to an adjacent traveling area (adjacent lane) adjacent to the self-traveling area (self-lane). The lane change assistance control may be referred to as a LCA. Details of the lane change support control are described in Japanese Unexamined Patent Application Publication No. 2018-103769 (JP 2018-103769 A).

In both the lane keeping control and the lane change assist control, ECU 20 acquires the target steering angle θtgt based on the image-data. ECU 20 controls the steering motor 40 so that an auto-steering torque Tr for matching the steering angle θ with the target steering angle θtgt is generated in the steering mechanism 42.

### Stopping Collision Risk

CPU acquires a risk index value In representing a stopping-time collision risk based on at least one of the following (1) to (5).
(1) The closest distance Dmin when VA of vehicles traveling on the “predicted route PR when the steering control is stopped” approaches the object
(2) Driver's gripping condition of the steering wheel
(3) Type of roadway VA is currently traveling on
(4) The number of pedestrians and/or bicycles present in a predetermined area in front of the vehicle VA
(5) Vehicle speed Vs

### (1) Closest Proximity Dmin

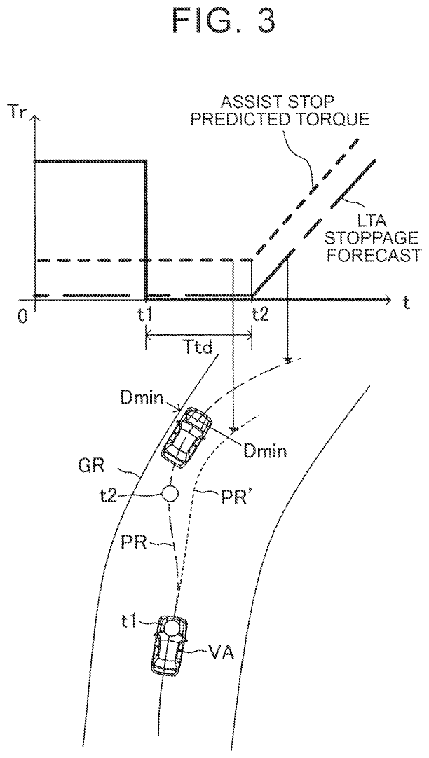

In the embodiment illustrated in FIG. 3, a process of acquiring the closest distance Dmin when LTA (first lane keeping control) is executed as the steering control will be described.

In the embodiment illustrated in FIG. 3, it is assumed that LTA being executed at the time point t1 when the vehicle VA is traveling on the curve is stopped for some reason. For the following reasons 1 and 2, the steering torque Tr is “0” at the time point t1.

Reason 1: LTA is running immediately before the time point t1. Therefore, the steering motor 40 generates a steering torque (auto-steering torque) Tr for matching the steering angle θ with the target steering angle θtgt of LTA in the steering mechanism 42. However, since LTA is stopped at the time point t1, the auto-steering torque Tr is “0”.

Reason 2: When LTA is being executed, the driver only grips the steering wheel and does not perform the steering operation (that is, the driver does not generate the steering torque Tr).

CPU estimates a future steering angle θft on the basis of the present steering angle θ, assuming that the following assumptions 1 and 2 are satisfied.

Assumption 1: The driver starts the steering operation at the time point t2 when the predetermined period of Ttd has elapsed from the time point t1.

Assumption 2: After the time point t2, the driver performs a steering operation so that the steering torque Tr is increased at a constant rate (see the dashed-dotted line in the graph of FIG. 3).

CPU estimates the predicted route PR of the vehicle VA after LTA is stopped based on the future steering angle θft, the current vehicle speed Vs, and the current yaw rate Yr. CPU acquires, as the closest approach distance Dmin, a distance (specifically, a distance in the vehicle widthwise direction of the vehicle VA) when the vehicle VA traveling on the predicted route PR approaches the object (the guardrail GR on the left side of the vehicle VA in the example illustrated in FIG. 3).

The shorter the closest Dmin is, the higher the stopping collision-risk is. CPU obtains the inverse of the closest distance Dmin as a risk index value In. Therefore, the larger the risk index value In is, the higher the stopping-time collision risk is.

The change in the steering torque Tr when the steering motor 40 is unable to generate the assist torque for some reason when LTA is not executed is indicated by a dotted line in the upper graph of FIG. 3. The predicted route PR′ is indicated by a dotted line below FIG. 3.

This is different from the case where LTA is executed in that the driver generates the predetermined steering torque Tr before the time point t1 when LTA is not executed. This difference in steering torque Tr is a difference between the predicted route Pr and the predicted route Pr′.

### (2) Gripping Condition

CPU identifies whether the driver's steering wheel is in a non-gripping state, a one-hand gripping state, or a non-gripping state based on the detected value from the contact sensor 36.

The non-gripping state is a state in which the driver does not grip the steering wheel. In the non-gripping state, the response time from the stop of the steering control until the driver starts the steering operation becomes the longest. Therefore, the collision risk at the time of stopping in the non-gripping state is the highest.

The state of holding both hands is a state in which the driver holds the steering wheel with both hands. In the state of holding both hands, the above-described correspondence time is shortest. Therefore, the risk of collision at the time of stopping in the state of gripping both hands is the lowest.

The one-handed grip state is a state in which the driver grips the steering wheel with one hand. In the one-handed gripping state, the corresponding time is shorter than the corresponding time in the non-gripping state and longer than the corresponding time in the two-handed gripping state. Therefore, the stopping collision risk in the one-handed gripping state is lower than the stopping collision risk in the non-gripping state and higher than the stopping collision risk in the two-handed gripping state.

CPU sets the risk index value In to the non-grip value Ina when the grip state is the non-grip state. CPU sets the risk index value In to the one-hand grip value Inb when the grip state is the one-hand grip state. CPU sets the risk index value In to the two-hand grip value Inc when the grip state is the two-hand grip state. The non-grip value Ina is set to the maximum value among the non-grip value Ina, the one-hand grip value Inb and the two-hand grip value Inc, and the two-hand grip value Inc is set to the minimum value.

### (3) Road Type

CPU acquires the road type information from the navigation device 24, and identifies the type of the road on which the vehicle VA is currently traveling based on the road type information.

In general, the width of the traveling area tends to be different depending on the type of the road. For example, among the prefectural roads of the expressway, the national road of the general road, and the general road, the lateral width of the traveling area of the expressway is the largest, followed by the lateral width of the traveling area of the general road, and the lateral width of the traveling area of the prefectural road of the general road is the narrowest.

The wider the lateral width of the traveling area, the more easily the vehicle VA pops out of the traveling area when the steering control is stopped. Therefore, the wider the lateral width of the traveling area, the higher the possibility that the vehicle VA collides with an object outside the traveling area when the steering control is stopped (that is, the risk of collision at the time of stopping becomes higher). Therefore, CPU acquires the risk index value In such that the width of the traveling area specified by the type of the roadway becomes smaller and larger.

CPU may acquire the image data from the front camera 22, acquire the lateral width of the traveling area in which the vehicle VA is currently traveling based on the image data, and acquire the risk index value In based on the lateral width.

(4) Number of Pedestrians and/or Bicycles

CPU is configured to determine the number of pedestrians and/or bicycles that are present outside the self-traveling area.

The greater the number of pedestrians and/or bicycles present outside the free-running area, the greater the likelihood that the vehicle VA will collide with these pedestrians and/or bicycles when the steering control is stopped (i.e., the higher the risk of stopping collisions). Therefore, CPU acquires the risk index value In such that the larger the number of pedestrians and/or bicycles is, the greater the risk index value In is.

### (5) Vehicle Speed Vs

CPU acquires the risk index value In so as to increase as the vehicle speed Vs increases. As the vehicle speed Vs increases, the centrifugal force increases, and as the vehicle speed Vs increases, the stopping collision-risk increases.

As an example, the risk index value In is obtained by applying In5 from the risk index value In1 acquired by CPU on the basis of the above (1) to (5) to the following expression (1).

$$In = α1 \cdot In 1 + α2 \cdot In 2 + α3 \cdot In 3 + α4 \cdot In 4 + α5 \cdot In 5 \qquad ( 1 )$$

The values α1 to α5 in the above expression (1) are weighting coefficients, and are set to appropriate values of “0” or more and “1” or less.

CPU may acquire the risk index value In based on at least one of the risk index values In1 to In5.

### Control Amount C, Target Control Amount Ctgt, and Upper Limit Control Amount Clmt

As described above, CPU changes the steering torque Tr when the steering control is executed. When the steering torque Tr is changed, the steering angle θ and the lateral acceleration Gy are also changed. Therefore, the control amount C of the steering control can be expressed as any one of the steering torque Tr, the steering angle θ, and the lateral acceleration Gy. The target control quantity Ctgt is also represented by any one of the steering torque Tr, the steering angle θ, and the lateral acceleration Gy. Similarly, the upper limit control quantity Clmt is represented by any one of the steering torque Tr, the steering angle θ, and the lateral acceleration Gy.

CPU may change the upper limit vehicle speed Vlmt when the second lane keeping control is executed as the steering control based on the risk index value In. Specifically, CPU may change the upper limit vehicle speed Vlmt such that the lower the stopping collision risk (that is, the smaller the risk index value In), the lower the upper limit vehicle speed Vlmt. Thus, the driver does not have to grip the steering wheel even if the vehicle speed Vs is relatively high.

### Cause of Stopping Steering Control

When the cause 4 occurs from the following cause 1, CPU stops the steering control.

Cause 1: When a failure of a component related to steering control (such as the steering motor 40 and a “component constituting the steering mechanism 42”) is detected

Cause 2: When dirt adheres to the lens of the front camera 22 and when the lens is shielded

Cause 3: When the temperature outside the vehicle cabin is outside the operable range of the electronic component

Cause 4: When the detection accuracy of the object of the front camera 22 decreases

### Presentation Screen

When the upper limit control amount Clmt is equal to or less than the predetermined first threshold value, CPU causes the display device 44 to display a first presentation screen for presenting to the driver that the upper limit control amount Clmt is set low. On the other hand, when the upper limit control amount Clmt is equal to or larger than the predetermined second threshold value, CPU causes the display device 44 to display a second presentation screen for presenting to the driver that the upper limit control amount Clmt is set high.

Thus, the driver can grasp the height of the upper limit control quantity Clmt. Therefore, even if the driver feels uncomfortable with respect to the steering control, it can be grasped that the reason is due to the upper limit control quantity Clmt.

The driving assistance device 10 is applicable to vehicles such as an engine-driven vehicle, a hybrid electric vehicle, plug-in hybrid electric vehicle, fuel cell electric vehicle, and a battery electric vehicle.

The present disclosure can also be regarded as a non-transitory storage medium in which a program for realizing the functions of the device 10 is stored and which is readable by a computer.

What is claimed is:

1. A vehicle control device that executes steering control for causing a control amount for a vehicle in a lateral direction to coincide with a target control amount acquired based on a surrounding environment of the vehicle, wherein the vehicle control device is configured to:
set an upper limit value of the target control amount, when the steering control is executed, to a larger value as a stopping collision risk that the vehicle collides against an object when it is assumed that the steering control is stopped is lower; and
execute the steering control such that the control amount does not become larger than the upper limit value.

2. The vehicle control device according to claim 1, wherein the vehicle control device is configured to acquire the stopping collision risk based on a shortest distance to the object from the vehicle traveling on a predicted route to be taken when the steering control is stopped.

3. The vehicle control device according to claim 1, wherein the vehicle control device is configured to acquire the stopping collision risk based on a state in which a driver grips a steering wheel of the vehicle.

4. A vehicle control method for a computer mounted on a vehicle to execute steering control for causing a control amount for the vehicle in a lateral direction to coincide with a target control amount acquired based on a surrounding environment of the vehicle, the vehicle control method comprising:
a first step in which the computer sets an upper limit value of the target control amount, when the steering control is executed, to a larger value as a stopping collision risk that the vehicle collides against an object when it is assumed that the steering control is stopped is lower; and
a second step in which the computer executes the steering control such that the control amount does not become larger than the upper limit value.

5. A non-transitory storage medium storing a program that causes a computer mounted on a vehicle to execute steering control for causing a control amount for the vehicle in a lateral direction to coincide with a target control amount acquired based on a surrounding environment of the vehicle, the program comprising:
a first step of causing the computer to set an upper limit value of the target control amount, when the steering control is executed by the computer, to a larger value as a stopping collision risk that the vehicle collides against an object when it is assumed that the steering control is stopped is lower; and
a second step of causing the computer to execute the steering control such that the control amount does not become larger than the upper limit value.
